(19) United States
(12) Patent Application Publication
(10) Pub. No.: US 2022/0137802 A1
(43) Pub. Date: May 5, 2022

(54) METHOD AND APPARATUS FOR GENERATING INTERACTIVE VISUALIZATIONS OF LARGE DATA SETS

(71) Applicant: CLAIMFOUND, INC., Gainesville, FL (US)

(72) Inventors: Nicholas Andrew DeROBERTIS, Sarasota, FL (US); Christoffer Dylan PROMPOVITCH, Gainesville, FL (US)

(21) Appl. No.: 17/202,883

(22) Filed: Mar. 16, 2021

Related U.S. Application Data
(60) Provisional application No. 63/107,014, filed on Oct. 29, 2020.

(51) Int. Cl. G06F 3/0484; G06F 3/0481; G06F 16/9035; G06F 16/9038

(52) U.S. Cl. CPC G06F 3/04847; G06F 3/04845; G06F 16/9038; G06F 16/9035; G06F 3/04817

(57) ABSTRACT

A method includes extracting data from a log file including location information and identification information. The method also includes normalizing the data and processing the normalized data to determine at least one of the quantity of data points corresponds to the location information. The method further includes processing graphical background data to determine a plurality of available zoom levels and processing the normalized data with respect to the graphical background data and each zoom level of the plurality of available zoom levels to determine a quantity of data points within a predetermined distance from a reference position in the graphical background data. The method additionally includes causing a graphical user interface to be output including a graphical representation of the graphical background data at a selected zoom level of the plurality of available zoom levels and one or more icons displayed over the graphical representation of the graphical background data.

### PRIORITY

The present application claims priority to U.S. Provisional Patent Application No. 63/107,014, filed on Oct. 29, 2020, which is incorporated by reference herein in its entirety.

### BACKGROUND

Service providers are continually challenged to deliver value and convenience to consumers by, for example, providing compelling network services that increase user interest and promote user interaction with a device or service. Conventional systems for generating user interfaces that display large data sets often frustrate users because of long processing times and high computing resource consumption.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a system capable of generating visualizations of large data sets, in accordance with one or more embodiments.

FIG. 2 is a diagram of the components of a management platform, in accordance with one or more embodiments.

FIG. 3 is a flowchart representing processes for generating interactive visualizations of large data sets, in accordance with one or more embodiments.

FIG. 4 is a flowchart representing processes associated with a data pipeline for generating interactive visualizations of large data sets, in accordance with one or more embodiments.

FIG. 5 is a flowchart representing processes associated with a back-end server for generating interactive visualizations of large data sets, in accordance with one or more embodiments.

FIG. 6 is a flowchart of a process for generating interactive visualizations of large data sets, in accordance with one or more embodiments.

FIG. 7 is a user interface flow diagram utilized in the processes of FIG. 6, according to various embodiments.

FIG. 8 is a functional block diagram of a computer or processor-based system upon which or by which some embodiments are implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

As used herein, the term summary dimensions refers to one, two, three, or four dimensions of data to be displayed to a user in a summary format.

As used herein, the term detail dimensions refers to the dimensions of the data which are not summary dimensions, but may be viewed upon interacting with an individual data point.

As used herein, the term level of aggregation refers a range of the summary dimensions which are displayed to the user at a single time.

As used herein, the term aggregation window refers to a particular range of the summary dimensions which are displayed to the user at a single time. Every aggregation window is associated with a level of aggregation. There may be multiple aggregation windows for any level of aggregation. In some embodiments, aggregation windows for a given level of aggregation have a same difference range between a minimum value and a maximum value of each dimension.

As used herein, the term static summaries refers to summaries of the data which are calculated in advance of a user input indicative of a request for a decrease in the level of aggregation for which summaries of the data are not calculated in advance by a data pipeline.

As used herein, the term dynamic summaries refers to summaries of the data which are calculated in response to a user input indicative of a request for a decrease in the level of aggregation for which static summaries are not calculated in advance by the data pipeline.

As used herein, the term original data points refers to the data points provided or based on information provided by a data source.

As used herein, the term aggregate points refers to one or more individual data points at various levels of aggregation.

As used herein, the term structured response refers to a combination of the summaries, static or dynamic, and/or aggregate points that is structured in a way to be processed for generating a graphical user interface.

As used herein, the term aggregation level cutoff refers to a level of aggregation based upon which data points will be processed to generate static summaries for levels of aggregation greater than the aggregation level cutoff and based upon which data points will be processed to generate dynamic summaries for levels of aggregation lower than the aggregation cutoff.

As used herein, the term perceived distance refers to the distance based on the summary dimensions between two data points or summaries displayed by way of a graphical user interface relative to a size of a viewable space displayed by the graphical user interface.

As used herein, the term zoom control refers to a widget for controlling a zoom level of a graphical user interface and which facilitates directly decreasing or increasing a corresponding level of aggregation centered around a midpoint of ranges of each summary dimension in a displayed aggregation window. If, for example, a user interacts with a “+” on the widget, the zoom level increases and the level of aggregation decreases, and if the user interacts with a “−” on the widget, the zoom level decreases and the level of aggregation increases.

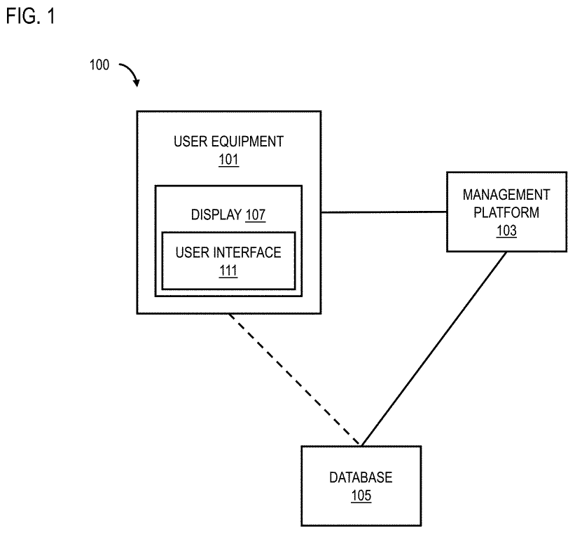

FIG. 1 is a diagram of a system 100, in accordance with one or more embodiments. As shown in FIG. 1, the system 100 comprises a user equipment (UE) 101 having connectivity to a management platform 103, and a database 105.

The UE 101, the management platform 103 and the database 105 are modular components of a special purpose computer system. In some embodiments, one or more of the UE 101, the management platform 103, and the database 105 are unitarily embodied in the UE 101. The UE 101, accordingly, comprises a processor by which the management platform 103 is executed. In some embodiments, one or more of the UE 101, the management platform 103 and/or the database 105 are configured to be located remotely from each other. By way of example, the UE 101, the management platform 103, and/or the database 105 communicate by wired or wireless communication connection and/or one or more networks, or combination thereof.

The UE 101 is a type of mobile terminal, fixed terminal, or portable terminal including a desktop computer, laptop computer, notebook computer, netbook computer, tablet computer, wearable circuitry, mobile handset, server, gaming console, or combination thereof. The UE 101 comprises a display 107 by which a user interface 111 is displayed. In some embodiments, display 107 is separate from UE 101, and UE 101 has connectivity to display 107.

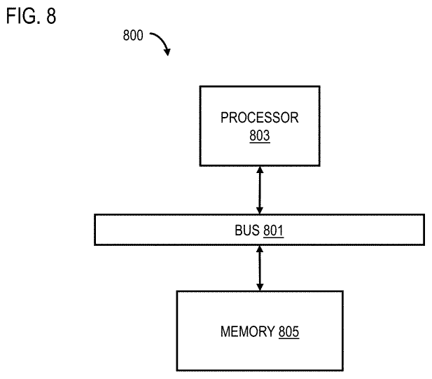

Management platform 103 is a set of computer readable instructions that, when executed by a processor such as a processor 803 (FIG. 8), facilitates the connectivity between the UE 101 and database 105. In some embodiments, the management platform 103 causes information associated with one or more data points capable of being plotted in a user interface-provided display space such as over graphical background data comprising, for example, a graphical canvas, a map, two-dimensional display data, three-dimensional display data, or some other suitable backdrop or manner by which one or more data points are capable of being representatively presented with respect to a reference position by way of a display, or other suitable information to be stored in the database 105. In some embodiments, the management platform 103 is configured to cause one or more external data sources to be queried and data received therefrom to be optionally stored in the database 105. In some embodiments, the management platform 103 is configured to cause data received from one or more external data sources by way of a push, for example, to be optionally stored in the database 105. In some embodiments, management platform 103 is a monitoring system that schedules the collection of data from one or more external data sources to be conducted periodically, or to be performed in real-time. In some embodiments, data received from one or more external data sources are received as log files comprising information associated with one or more data points that are generated or updated.

Database 105 is a memory such as a memory 805 (FIG. 8) capable of being queried or caused to store data associated with the UE 101, information associated with one or more data points usable for plotting in a user interface-provided display space such as over a background data comprising, for example, a graphical canvas, a map, two-dimensional display data, three-dimensional display data, or some other suitable backdrop or manner by which one or more data points are capable of being representatively presented with respect to a reference position by way of a display, or other suitable information.

Organizations have increasing amounts of data, and often want to display that data to users in a meaningful way. Most data visualizations either show a summary of the data or plot the individual points. In applications where both the summaries and the individual data points are useful to the end user, it is often desirable to have a visualization that displays both. Displaying more than a few thousand points, however, quickly clutters the visualization and makes extracting meaning from the displayed data difficult.

Zooming in and out of the data in a visual representation of the data sometimes helps with a user's ability to comprehend the data. For example, summaries of multiple data points are sometimes produced when zoomed out and the summaries of the multiple data points are caused to change to individual points upon zooming in. The capability to visually convey data, however, is often limited as a quantity of data points increases beyond a few thousand data points. The computation time to calculate the summaries of data points when dealing with more than a few thousand data points becomes prohibitively large to the point that it decreases user interest and reduces user engagement with a user interface by which the visual data is conveyed.

For example, when processing a database comprising 24 million unclaimed property records in the state of Florida to generate a visual representation of the unclaimed property records plotting 24 million unclaimed property records over a map of the state of Florida, calculating the summaries when zoomed out using conventional methods takes more than an hour. User interest and engagement often decreases when queries take inordinate amounts of time. Users, however, have become accustomed to obtaining query results in as fast as 200 milliseconds (ms), regardless of the size of a given data set. The system 100 makes it possible to generate interactive maps while responding to a query in under 200 ms.

In some embodiments, management platform 103 executes a process for generating interactive visualizations of large data sets to be able to performantly display tens of millions (or more) data points on an interactive background such as a map while responding to one or more queries within 200 ms by, for example, pre-processing the data points in accordance with one or more rules.

The following description provides a non-limiting example use-case for ease of discussion. While specific embodiments are discussed herein and are illustrated in the drawings appended hereto, the system 100 encompasses a broader spectrum than the specific subject matter described and illustrated. As would be appreciated by those skilled in the art, the example embodiments described herein provide but a few examples of the broad scope of the system 100.

The management platform 103 is configured to implement a process for generating interactive visualizations of large data sets comprising data associated with abandoned property, monetary claims, or other suitable information to display large quantities of data points on the order of about 24 million data points indicative of unclaimed property with respect to a location on an interactive map.

In use, management platform 103 causes user interface 111 to be output by way of display 107 of UE 101. User interface 111 is a graphical user interface, wherein a user initially sees a zoomed-out view of a map representative of a country, state, city, or county, and one or more cluster symbols, or summaries, comprising numerical quantities of unclaimed property records that exist in a viewable area of the displayed map. Based on a selection of one of the one or more cluster symbols, or based on a received user input to increase a zoom level, management platform 103 causes a range of summary dimensions such as a latitude and longitude range represented by the displayed map to decrease. Management platform 103 then causes additional smaller clusters and/or individual data point symbols to be displayed over the displayed map based on one or more of a preset quantity of data points allowed to be indicated by a cluster symbol or a zoom level, in accordance with at least one rule. Based on a selection of an individual data point symbol, management platform 103 causes additional details about the unclaimed property record associated with the selected individual data point symbol to be displayed by way of user interface 111.

In this example, summary dimensions are latitude and longitude of an unclaimed property address. Based on a selection of an individual data point in the user interface 111, management platform 103 is configured to cause detail dimensions to be displayed. In some embodiments, the detail dimensions comprises one or more of the name of a claimant, a dollar value of the unclaimed property, a company which reported the unclaimed property, or other suitable information. The levels of aggregation correspond to how zoomed in the displayed map is. In some embodiments, management platform 103 is configured to modify the displayed map based on at least two different zoom levels. In some embodiments, management platform 103 is configured to modify the displayed map based on at least five different zoom levels. In some embodiments, management platform 103 is configured to modify the displayed map based on at least 10 different zoom levels.

In some embodiments, management platform 103 is configured to modify the displayed map based on at least 15 different zoom levels. In some embodiments, management platform 103 is configured to modify the displayed map based on at least 20 different zoom levels. In some embodiments, management platform 103 is configured to modify the displayed map based on at least some other suitable quantity of different zoom levels. In some embodiments, management platform 103 is configured to modify the displayed map based on at least a quantity of different zoom levels having a corresponding quantity of levels of aggregation.

In implementing the process for generating interactive visualizations of large data sets, to plot the, for example, 24 million points at 20 levels of aggregation, management platform 103 is configured to generate 8 million clusters in advance. In some embodiments, management platform 103 is configured to preset a zoom level of 17 out of 20 as the cutoff for pre-calculated summaries, wherein zoom levels 1 (most zoomed out, largest level of aggregation) to 17 are calculated in advance while zoom levels 18, 19, and 20 are calculated dynamically by the management platform 103 based on a user input to increase the zoom level, or select a displayed summary. In some embodiments, a quantity of zoom levels for which advanced processing is done is based on a percentage of available zoom levels. In some embodiments, a quantity of zoom levels for which advanced processing is done is based on a preset quantity of the available zoom levels, the preset quantity of the available zoom levels being based on a quantity of data points within a predefined display space. For example, if a first predefined display space is a map of the state of Florida and a second predefined display space is a map of the state of Idaho, wherein a quantity of data points associated with Florida is greater than a quantity of data points associated with Idaho, management platform 103 may pre-process data points for more zoom levels for data points associated with Florida than for data points associated with Idaho.

In some embodiments, management platform 103 initially calculates summaries using a K-Means algorithm then, if the summaries are too large for the level of aggregation, management platform 103 splits the summaries by repeatedly evenly dividing the summary areas into two summaries until each summary is smaller than the aggregation window.

In some embodiments, management platform 103 is configured to cause quantities of data to be displayed that are conventionally too large to send to a user interface, and yet allow the user to see meaningful summaries of the data and interact with those summaries to select and view any individual data point in the large set.

Management platform 103 is configured to facilitate a user selection of a summary to zoom in and view the contents of that summary, be it individual points or further summaries. In some embodiments, management platform 103 makes it possible for a user to separately control the zoom level to view the summaries at differing levels of aggregation.

In some embodiments, management platform 103 causes data points to be displayed on a map based on latitude and longitude. In some embodiments, management platform 103 causes data to be displayed with respect to a reference point based on one dimension, two dimensions, three dimensions, four dimensions, or some other suitable quantity of dimensions of all the data and enable the user to view one or more other dimensions of any individual data point or take action relating to that data point.

In some embodiments, management platform 103 causes one or more operations to occur based on a corresponding trigger. In some embodiments, a trigger is associated with causing an operation to occur based on a context of the source of the trigger. In some embodiments, the contexts comprise a pipeline context and a request context.

The pipeline context is triggered by a data availability event. In some embodiments, every time there is new data available from a data source, the data pipeline is triggered. In some embodiments, management platform 103 is configured to query one or more external data sources in accordance with a predefined schedule. In some embodiments, management platform 103 is configured to continuously query one or more external data sources in accordance with a predefined schedule. In some embodiments, management platform 103 is configured to continuously query one or more external data sources to detect an immediate change in the data made available by the data source. In some embodiments, management platform 103 is configured to facilitate receiving data from one or more external data sources in accordance with a predefined schedule. In some embodiments, management platform 103 is configured to continuously facilitate receiving data from one or more external data sources in accordance with a predefined schedule. In some embodiments, management platform 103 is configured to continuously facilitate receiving data from one or more external data sources to detect an immediate change in the data made available by the data source.

The request context is triggered based on a user input to increase a zoom level based on an interaction with a zoom controller or a summary, view information associated with a single data point or a grouping of data points, or some other suitable on-demand request instruction based on a user interaction with an application associated with the graphical user interface. In some embodiments, management platform 103 is configured to execute operations triggered in the request context many times simultaneously to support multiple users. In some embodiments, the request context is triggered without any user interaction. In some embodiments, the request context is triggered in accordance with a predefined schedule.

In some embodiments, management platform 103 processes data from a single data source having a uniform format. In some embodiments, management platform 103 processes data from multiple data sources having a uniform format. In some embodiments, management platform 103 processes data from a single data source having an unstructured format. In some embodiments, management platform 103 processes data from multiple data sources having unstructured formats. In some embodiments, a data source comprises an external database communicatively coupled with management platform 103.

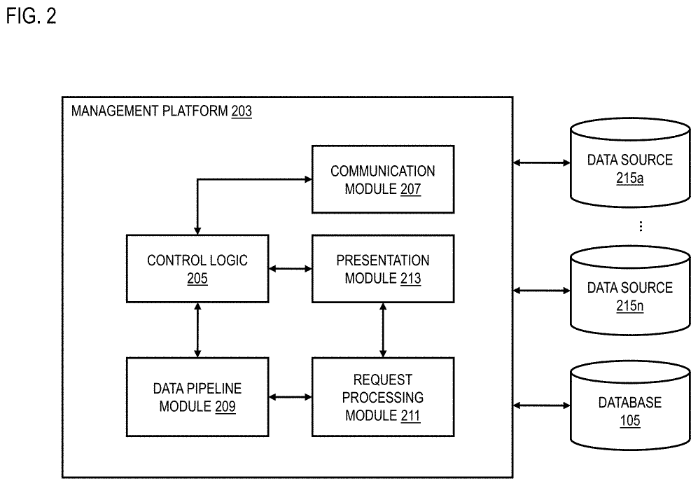

FIG. 2 is a diagram of the components a management platform 203, in accordance with one or more embodiments. Management platform 203 is usable as management platform 103 (FIG. 1). Management platform 203 is a set of computer readable instructions that, when executed by a processor such as a processor 803 (FIG. 8), facilitates generating interactive visualizations of large data sets.

By way of example, the management platform 203 includes one or more components for generating interactive visualizations of large data sets. It is contemplated that the functions of these components may be combined in one or more components or performed by other components of equivalent functionality. The management platform 203 includes a control logic 205 that facilitates interactions between various components of management platform 203.

Management platform 203 also includes a communication module 207, a data pipeline module 209, a request processing module 211, and a presentation module 213. Management platform 203 has connectivity with one or more external data sources 215a-215n (collectively referred to herein as “external data source 215”), database 105, and UE 101 (FIG. 1). Communication module 207 facilitates the sending and receiving of data between management platform 203 and external data source 215, database 105, and UE 101.

Data pipeline module 209 is configured to transform data received from a data source such as data source 215 or database 105 into a predefined structure for supporting an interactive user interface, such as user interface 111 (FIG. 1). The data pipeline module 209 then loads the structured data into database 105. In some embodiments, database 105 is a database which has a schema designed to support the interactive user interface. In some embodiments, the database 105 stores an application database comprising one or more data structures designed to support the interactive user interface. In some embodiments, the schema and/or application database comprises a data structure that is based on one or more XML templates. In some embodiments, the data received from the data source is in the form of a log file. In some embodiments, data pipeline module 209, or some other suitable component of management platform 103, is a monitoring system that schedules the collection of data from one or more external data sources 215 to be conducted periodically, or to be performed in real-time. In some embodiments, data received from one or more external data sources are received as log files comprising information associated with one or more data points that are generated or updated.

In some embodiments, data pipeline module 209 is configured to recognize and parse data within log files for each of a plurality of different file formats to enable oversight of data activity one or more of a plurality of applications or one or more computer environments for determining a quantity of data points based on a correspondence between identification information and location information included in the log file. For example, different data sources 215 may have different data structures or formats, or be associated with different applications or computer environments. The data pipeline module 209 makes it possible to recognize changes in data, new data or updated data, for example, across several different data sources 215 by restructuring the received data, or log files, into a structured form that is appropriate for the presentation module 213 to generate the user interface and provide visualized data sets as discussed herein.

In some embodiments, data pipeline module 209 is configured to extract data included received log files using, for example, a parsing engine. In some embodiments, the parsing engine is an application that is configurable, for example, by using XML templates. In some embodiments, the parsing engine maintains XML templates (as an example of a standard format for location information or identification information) based on known location information and identification information received from one or more data sources 215. In some embodiments, the XML templates also comprise information that identifies correlations between location information and identification information in the log files, and may further comprise information on what is to be extracted from the log files for subsequent analysis, storage and reporting. For example, the XML template may comprise the format of the data contained in the log file so that the data in the log file may be easily correlated to known fields based on the XML template information. XML templates are one example of such a template that may be used, and other similar templates or mapping techniques could also be used. In some embodiments, for never previously encountered data formats, the parsing engine may be configured via manual definition and manipulation of a default XML template to create a suitable XML template, or configured via a tool with a graphical user interface to define the data format.

In some embodiments, data pipeline module 209 is configured to transform data received from a data source such as data source 215 or database 105 into a predefined structure for supporting an interactive user interface, such as user interface 111, by normalizing the data (using, for example, the above described templates) into records that are suitable for analysis, storage and reporting.

In some embodiments, as part of the normalization process, an event source identifier (or event log identifier), date/time, source network address, destination network address, text associated with the event, and transaction code may be placed into the record. In some embodiments, based on the source identifier, additional information may optionally be stored in the record that may not be part of a standard normalized record. For example, a received log file may include information correlating the identification information to the location information. In some embodiments, the log file comprises, and the data pipeline module 209 is configured to recognize, parse, and normalize data associated with one or more of a geographical location or a property address a date, a time, a person, a surname, a first name, a personal identifier, a birth date, a person's sex, a social security number, an ancestral tree, money, a tangible asset, or other suitable information and determine a correspondence between the identification information and the location information.

In some embodiments, the data pipeline module 209 is configured to normalize and correlate identification information and location information using, for example, one or more rules, algorithms, database queries, executed by a processor, or modeled and stored in XML templates, or other template, for example.

In some embodiments, data pipeline module 209 is flexible in its ability to read and recognize changes in data for generating the user interface 111. In some embodiments, an application layer protocol such as Simple Network Management Protocol (SNMP) is used to facilitate the exchange of information between management platform 203 and data sources 215. In some embodiments, data sources 215 are configured to give management platform 203 programmatic input (or read) access to a log file stored, created, or made available, by a data source 215. In some embodiments, a log file stored, created or made available by a data source 215 may be accessible via a local hard drive, a network hard drive, and/or may be transferred locally via a file transfer protocol (FTP). In some embodiments, management platform 203 is configured to read from a local or remote database via protocols, such as Open Database Connectivity (ODBC), in order to access relevant log files. In some embodiments, data pipeline 209 is configured to generate a log file through the systematic extraction from one or more databases of data sources 215, and the generated log file(s) are then transported via FTP to database 105, for example. In some embodiments, management platform 203 is configured to provide a web service interface to receive log files, and/or location information and identification information, using a message protocol, such as Simple Object Access Protocol (SOAP).

As discussed above, data pipeline module 209, or some other suitable component of management platform 103, is a monitoring system that schedules the collection of data from one or more external data sources 215 to be conducted periodically, or to be performed in real-time. In some embodiments, the schedule can be time-based and/or can utilize other factors for determining the schedule, such as system activity. In some embodiments, the particular schedule can be related to the criteria of at least one rule. For example, a rule that monitors access to a data source 215, or a quantity of changes to one or more data sources 215, over a predetermined time period and, based upon which a transmission of data from a data source 215 may be triggers, may be scheduled to be processed at intervals of the predetermined time period. An example of an application that can be used to schedule the rule is Quartz, or some other suitable application.

In some embodiments, data pipeline module 209, or some other suitable component of management platform 203, is configured to facilitate adjustable or dynamic scheduling of a rule for triggering the transmission of data from the one or more data sources 215. In some embodiments, management platform 203 is configured to enable a user to designate, by way of a user interface for example, one or more criteria for scheduling a rule, and the schedule can be built and thereafter automatically adjusted, based upon the one or more criteria. For example, in some embodiments, management platform 103 is configured to cause a time interval between processing of the same rule to be adjusted based upon such factors as system activity, system resource limitations such as processing or memory resources, network bandwidth, processing times, user feedback, data source provider feedback, an amount of accessible data, or other suitable criteria.

Request processing module 211 waits for requests received based on a user interaction with the user interface, and based upon a received request, causes the presentation module 213 to retrieve data from database 105 and restructure the retrieved data to generate the user interface having the requested data. In some embodiments, presentation module 213 restructures the data such that UE 101, running an application having the user interface, is able to process the data for generating the user interface having the requested data in a visual form.

In some embodiments, request processing module 211 is split into a front-end module and a back-end module. In some embodiments, request processing module 211 is split into a back-end server and a front-end server. In some embodiments, request processing module 211 and the presentation module 213 are a back-end server and a front-end server. In some embodiments, the functions described with respect to the request processing module 211 are divided among, and executed by, separate hardware components comprising a back-end server and a front-end server. In some embodiments, the functions described with respect to the request processing module 211 and the presentation module 213 are divided among, and executed by, separate hardware components comprising a back-end server and a front-end server.

In some embodiments, the back-end server waits for requests from the user interface, and upon a request retrieves data from database 105 and restructures it into a format that the presentation module 213 is ready to consume for generating the user interface. In some embodiments, the front-end server waits for requests based on a user input and delivers the user interface in response to the user input.

The user interface generated or facilitated by the various components of management platform 203 allows the user to view the one, two, three, or four-dimensional data summaries and individual data points, navigate from the summaries to the individual data points, control the level of aggregation of the summaries, view additional dimensions of individual data points, and take actions relating to individual data points.

In some embodiments, management platform 203 is configured to implement at least one rule defining an appropriate level of aggregation for the summary dimensions. To maximize the speed at which summaries can be delivered to the user interface, the summaries are created by the data pipeline module 209 and stored in the database 105. The calculation of such summaries may be computationally expensive, in which case the speed of responding to a request is balanced with the time and resource expenditure to produce the summary.

To achieve the dual goals of minimizing both response time and resource expenditure, management platform 203 mixes strategies, wherein at larger levels of aggregation, summaries which involve greater numbers of data points are calculated in advance by the data pipeline module 209 and stored in the database 105, while at smaller levels of aggregation, the backend server retrieves the individual data points from the database 105 and dynamically produces the summaries while responding to the user request.

Management platform 203 is configured to use one or more approaches to determine which summaries will be calculated in advance by the data pipeline module 209 and which will be calculated dynamically by the request processing module 211 (or back-end server). In some embodiments, a fixed aggregation level cutoff is set, wherein larger levels of aggregation are calculated in advance while smaller levels of aggregation are calculated dynamically. In some embodiments, a more consistently performant strategy is set, wherein the dimensions are split evenly for each level of aggregation to yield smaller ranges of the dimensions, or windows, and then within each aggregation window, the data points are counted.

For example, aggregation windows, display areas, user interface screens, and/or summary dimensions for levels of aggregation, with a quantity of points above a preset cutoff would have summaries calculated in advance by the data pipeline module 209 and windows with a number of points below the preset cutoff would have summaries calculated dynamically by the request processing module 211 (or back-end server). In some embodiments, levels of aggregation for which summaries will be calculated by the data pipeline module 209 are preset in advance, while the levels of aggregation with dynamic summaries are optionally set in advance or the levels of aggregation are dynamic themselves based on some criteria such as a data type, a quantity of data points, a zoom level, an allocation of system resources, an available bandwidth, or some other suitable basis.

In some embodiments, the data pipeline module 209 is configured to respond to data availability events to take new data points, produce the static summaries and aggregate points through summary calculations, and load the summaries, aggregate points, and original data points into the database 105. The summary calculations are used by the data pipeline module 209 to produce the static summaries and aggregate points. The summary calculations are used by the request processing module 211 (or back-end server) to produce the dynamic summaries and aggregate points. The calculations will differ depending on the level of aggregation. In some embodiments, presentation module 213 causes the graphical user interface to be adjusted such that the perceived distance on the summary dimensions between original points increases as the level of aggregation decreases.

In some embodiments, data pipeline module 209 sorts original data points into summaries and/or aggregate points based on the perceived distance between the original data points, with lower perceived distances being sorted into summaries and higher perceived distances being sorted into aggregate points. Once an original data point is classified as an aggregate point at a given level of aggregation, for all lower levels of aggregation, that point does not enter the summary calculations and is treated as an aggregate point.

Data pipeline module 209 is configured to apply one or more algorithms for grouping nearby points into summaries such as K-means, DBSCAN, and OPTICS, or some other suitable algorithm. Data pipeline module 209 is configured to generate summaries that are to be displayed with fewer data points as the level of aggregation gets smaller so as to keep a relatively consistent number of summaries in the user interface. Regardless of which part of the data the user is viewing, management platform 203 causes a relatively consistent number of summaries to be displayed over the displayed interface unless the density of the points is vastly different.

In some embodiments, the algorithms discussed above, when applied on the entire level of aggregation, will generate some summaries which are larger than the aggregation window. In some embodiments, to resolve this issue, one or more components of management platform 203 is configured to split these large summaries into multiple smaller summaries so that the summaries are displayed within an aggregation window. This splitting process is optionally repeated by running the same algorithm on a smaller area based on an available display space or zoom level. In some embodiments, a simpler algorithm is applied such as generating new summaries evenly spaced apart within the original display space or based on a changed zoom level.

The database 105 houses the individual data points and the static summaries in a structure that enables the back-end server to quickly access the related data for a particular aggregation window.

In some embodiments, the original data points, summaries, and aggregate points are kept in three separate tables. In some embodiments, a relational database is used to maintain the relationship between the aggregate points and the individual data points. In some embodiments, all three tables are indexed by the summary dimensions and the summary and aggregate point tables are further indexed by the level of aggregation to enable fast retrieval of the data by the back-end server.

The request processing module 211 (or back-end server) responds to requests received by way of the user interface to populate the view using the structured response. Request processing module 211 is configured to process one or more of data received from UE 101, presentation module 213, or data pipeline module 209, for example, regarding the user interface to identify the current level of aggregation and the request processing module 211 (or back-end server) switches between the dynamic summaries and the static summaries based on the aggregation level cutoff. If it is a low level of aggregation, the dynamic strategy is used in which the same transformations applied in the data pipeline module 209 are applied to the original points to create the structured response in response to a user request. If it is a high level of aggregation, the static strategy is used in which the summaries and aggregate points are retrieved from the database 105 to produce the structured response.

The user interface generated by presentation module 213, or UE 101 based on data received from management platform 203, comprises background data comprising one or more of a canvas, a map, or a multi-dimensional space in which the aggregate points and summaries are plotted aligning with the summary dimensions. In some embodiments, the summaries and aggregate points have different visual representations, where summaries appear larger and optionally display summary information such as the number of original points which lie within the range of the summary dimensions of the summary.

If the user interacts with a summary, the user interaction triggers a change in the view to a lower level of aggregation. In some embodiments, management platform 203 causes the range of the summary dimensions in the new view to be proportional to that of the summary itself within the original view. Each time the user continues this pattern, management platform 203 causes the level of aggregation to decrease and causes the range of the summary dimensions to decrease, until there are no summaries left in the view, only individual non-aggregated points.

In some embodiments, the user interface comprises is a zoom control which facilitates directly changing the level of aggregation in either direction around the midpoint of the summary dimension ranges in a current aggregation window.

In some embodiments management platform 203 is configured to collect data regarding a duration of use of the user interface, most-used zoom levels, most used quantities of summarized data points based on a zoom level to identify an optimal quantity of summarized data for pre-processing, etc. In some embodiments, management platform 203 uses this data to set default zoom levels for pre-processing and/or adapt one or more rules which dictate an allowable quantity of data points to be included in a summary.

In some embodiments, the duration of use is based on an amount of time with which UE 101 is being interacted while manipulating the user interface, requesting or viewing data, etc. In some embodiments, the duration of use is based on how often, or in what ways, the user interface is manipulated or interacted with by way of UE 101, how often queries or logins are made, or some other suitable indicator. In some embodiments, one or more of a quantity of interactions, logins, queries, or other suitable indicator is recorded. In some embodiments, location of use is recorded. The recorded usage data is capable of being analyzed by the UE 101, the management platform 203, and/or a service provider to provide insight into user behavior and/or interest in the mapping application run by UE 101, or other suitable discoverable metrics.

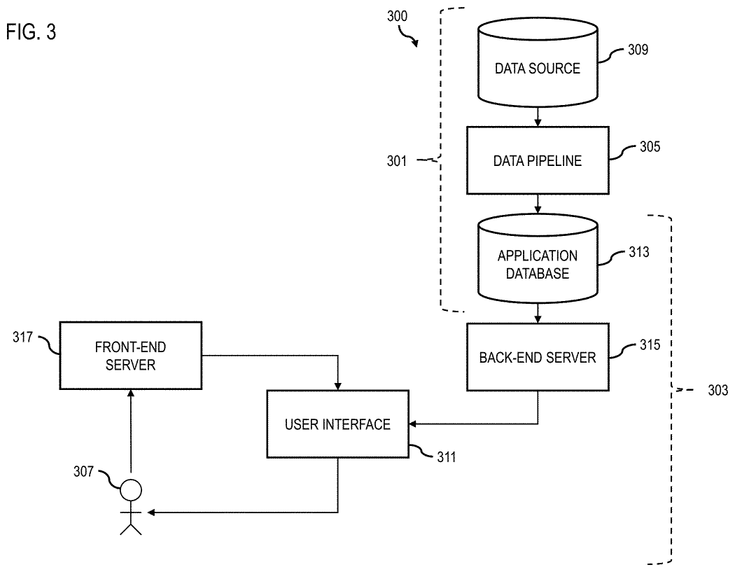

FIG. 3 is flowchart representing processes 300 for generating interactive visualizations of large data sets, in accordance with one or more embodiments.

The processes are optionally split into two contexts which are separated by what triggers the requisite operations: the pipeline context 301 and the request context 303.

The pipeline context 301 is triggered by a data availability event, such as when new data available or data is received from a data source, source, the data pipeline 305 is triggered.

The request context 303 is triggered by a user 307 using an application run by a UE.

The data source 309 represents where structured or unstructured data originates and may be an external database. The data pipeline 305, which corresponds to data pipeline module 209 (FIG. 2) in some embodiments, transforms the new data into the appropriate structure for supporting an interactive user interface 311, then loads the structured data into an application database 313. The application database 313 is a database which has a schema designed to support the interactive user interface 311. Application database 313 is, for example, stored in database 105 (FIG. 1).

The back-end server 315 waits for requests from the user interface 311, and upon a request is responsible for communicating with the application database 313 to retrieve the data and restructure it in a way that the user interface 311 is ready to consume it. The front-end server 317 waits for requests from the user 307 and delivers the user interface 311 in response.

The user interface 311 allows the user 307 to view the one, two, three, or four-dimensional data summaries and individual data points, navigate from the summaries to the individual data points, control the level of aggregation of the summaries, view additional dimensions of individual data points, and take actions relating to individual data points.

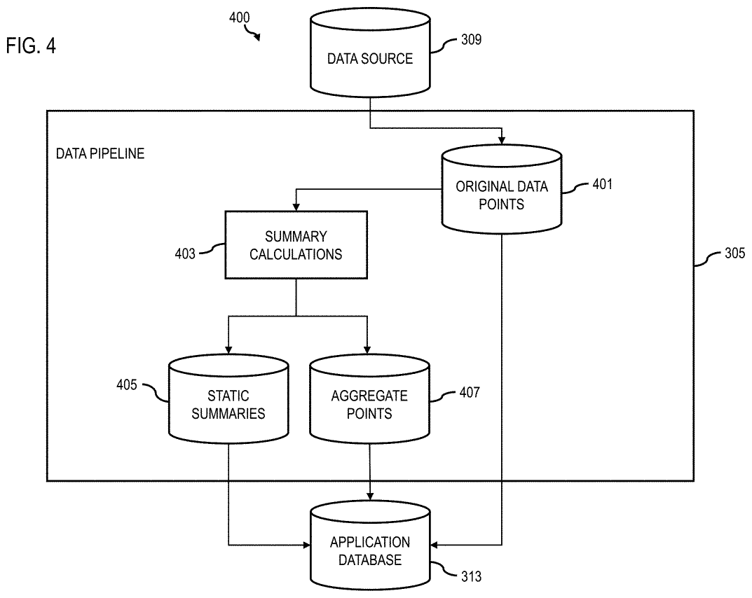

FIG. 4 is a flowchart representing processes 400 associated with data pipeline 305 for purposes of generating interactive visualizations of large data sets, in accordance with one or more embodiments.

Data pipeline 305 is configured to respond to data availability events to take new original data points 401 received from data source 309, perform summary calculations 403 to produce static summaries 405 and aggregate points 407 through the summary calculations 403, and load the static summaries 405, aggregate points 407, and original data points 401 into the application database 313.

The summary calculations 403 are used by the data pipeline 305 to produce the static summaries 405 and aggregate points 407, and by the back-end server 315 (FIG. 3) to produce the dynamic summaries and aggregate points.

The calculations will differ depending on the level of aggregation. In the user interface 311 (FIG. 3), as the level of aggregation decreases, the perceived distance on the summary dimensions between original points increases.

In some embodiments, original data points 401 are sorted into static summaries 405 or aggregate points 407 based on the perceived distance between the original points 401, with lower perceived distances being sorted into static summaries 405 and higher perceived distances being sorted into aggregate points 407. Once an original data point 401 is classified as an aggregate point 407 at a given level of aggregation, for all lower levels of aggregation, that point does not enter the summary calculations and is simply treated as an aggregate point 407.

Data pipeline 305 is configured to apply one or more algorithms for grouping nearby points into summaries 405 such as K-means, DBSCAN, and OPTICS, or some other suitable algorithm. Data pipeline 305 is configured to generate static summaries 405 that are to be displayed with fewer data points as the level of aggregation gets smaller so as to keep a relatively consistent number of summaries in the user interface 311. Regardless of which part of the data the user is viewing, a relatively consistent number of summaries is caused to be displayed over the displayed interface unless the density of the points is vastly different.

In some embodiments, the algorithms discussed above, when applied on the entire level of aggregation, will generate some summaries which are larger than the aggregation window. In some embodiments, to resolve this issue these large summaries are split into multiple smaller summaries so that the summaries are displayed within an aggregation window. This splitting process is optionally repeated by running the same algorithm on a smaller area based on an available display space or zoom level. In some embodiments, a simpler algorithm is applied such as generating new summaries evenly spaced apart within the original display space or based on a changed zoom level. Based on the zoom level and/or level of aggregation, if the summaries displayed are preprocessed by data pipeline 305, the summaries displayed are based on static summaries 405.

The application database 313 houses the individual original data points and the static summaries 405 in a data structure that allows the back-end server 315 to quickly access the related data for a particular aggregation window. The original data points 401, summaries 405, and aggregate points 407 are optionally kept in three separate tables. A relational database is optionally used to maintain the relationship between the aggregate points 407 and the individual original data points 401. All three tables are optionally indexed by the summary dimensions and the summary and aggregate points tables are optionally indexed by the level of aggregation to enable fast retrieval of the data by the back-end server 315.

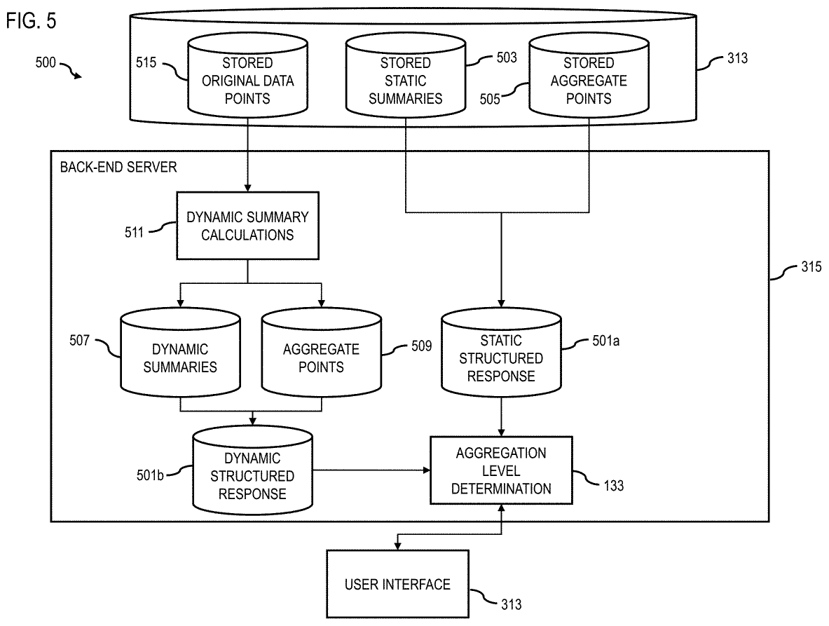

FIG. 5 is a flowchart representing processes 500 associated with back-end server 315 for generating interactive visualizations of large data sets, in accordance with one or more embodiments.

The back-end server 315 responds to requests received by way of user interface 311 to populate the view using a static structured response 501a or a dynamic structured response 501b. Static structured response 501a is based on the stored static summaries 503 and the stored aggregate points 505 which are stored in application database 313. Dynamic structured response 501b is based on the dynamic summaries 507 and the aggregate points 509 that are generated by back-end server 403 by applying dynamic summary calculation 511. Based on a user interaction that causes a request to be sent from a UE executing an application associated with user interface 311, the UE sends a current level of aggregation to the back-end server 315. The back-end server 315 comprises a logical switch that causes a switch between the dynamic summaries 507 and the static summaries 503 based on a preset aggregation level cutoff. Based on a determination 513 that the level of aggregation is a low level of aggregation (e.g., less than or equal to the preset aggregation level cutoff), the dynamic strategy is used by the backend server 315 in which the summary calculations, comprising the same transformations applied in the data pipeline 305 (FIG. 4), are applied to the original points 515 stored in the application database 313 to create the dynamic structured response 501b in response to a user request. If the level of aggregation is determined to be a high level of aggregation (e.g. greater than the preset aggregation level cutoff), the static strategy is used by backend server 315 in which the stored static summaries 503 and the stored aggregate points 505 are retrieved from the application database 313 to produce the static structured response 501a.

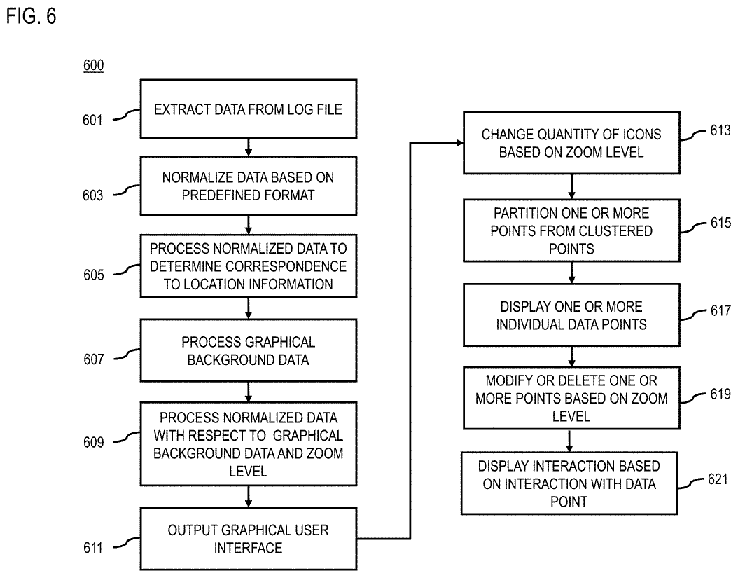

FIG. 6 is a flowchart of a process 600 for generating interactive visualizations of large data sets, in accordance with one or more embodiments. In some embodiments, the management platform 103 (FIG. 1) performs the process 600 and is implemented in, for instance, a chip set including a processor and a memory as shown in FIG. 8.

In step 601, management platform 103 causes data to be extracted from a log file including location information and identification information. The extracting is performed by a computer system configured to recognize and parse the data within the log file for each of a plurality of different file formats. The extracted data enables a monitoring system implemented by a processor to oversee data activity across one or more of a plurality of applications or one or more computer environments for determining a quantity of data points based on a correspondence between the identification information and the location information.

In some embodiments, the location information comprises one or more of a geographical location or a property address. In some embodiments, the identification information comprises data associated with one or more of a date, a time, a person, a surname, a first name, a personal identifier, a birth date, a person's sex, a social security number, an ancestral tree, money, or a tangible asset. In some embodiments, the graphical background data comprises map data. In some embodiments, the wherein the map data comprises a three-dimensional space.

In step 603, management platform 103 normalizes the data based on a predefined format.

In step 605, management platform 103 processes the normalized data to determine at least one of the quantity of data points corresponds to the location information. For example, management platform 103 processes the normalized data to determine at least one of the quantity of data points corresponds to the geographical location or the property address.

In step 607, management platform 103 processes graphical background data to determine a plurality of available zoom levels. The available zoom levels of the plurality of available zoom levels are indicative of an amount of graphical background data displayed by way of a user interface comprising the graphical background data. In some embodiments, management platform 103 processes map data to determine a zoom level indicative of a displayed point of view with respect to a user interface comprising the map data.

In step 609, management platform 103 processes the normalized data with respect to the graphical background data and each zoom level of the plurality of available zoom levels to determine a quantity of data points within a predetermined distance from a reference position in the graphical background data. In some embodiments, management platform 103 processes the normalized data with respect to the map data and the zoom level to determine a quantity of data points within a predetermined area of a geographic position in the map data.

In some embodiments, management platform 103 processes the normalized data according to a predefined schedule to generate the one or more icons for a preset quantity of the plurality of available zoom levels such that the one or more icons at the zoom levels of the preset quantity of zoom levels are fixed based on the normalized data and a first time at which the normalized data is processed according to the predefined schedule. In some embodiments, management platform 103 continuously processes the normalized data according to the predefined schedule to generate the one or more icons for the preset quantity of the plurality of available zoom levels such that the one or more icons at the zoom levels of the preset quantity of zoom levels are fixed based on the normalized data and the first time at which the normalized data is processed according to the predefined schedule. In some embodiments, the monitoring system processes the normalized data based on a user interaction with the user interface at a second time after the normalized data is processed according to the predefined schedule, to cause the one or more icons to change based on a determination the zoom level is greater than the zoom levels of the preset quantity of zoom levels.

In step 611, management platform 103 causes a graphical user interface such as user interface 111 (FIG. 1) to be output by a display, such as display 113 (FIG. 1). The graphical user interface comprises a graphical representation of the graphical background data at a selected zoom level of the plurality of available zoom levels. In some embodiments, the graphical user interface comprises a graphical representation of the map data at a selected zoom level.

The graphical user interface also comprises one or more icons displayed over the graphical representation of the graphical background data. In some embodiments, the icons of the one or more icons are representative of summaries, static and/or dynamic, as discussed above with respect to FIGS. 2-5, for example.

In some embodiments, the one or more icons comprise a number indicative of the quantity of data points within the predetermined distance of the reference position. In some embodiments, a quantity of the one or more icons is based on a preset allowable quantity of data points to be indicated by a single icon based on the selected zoom level. In some embodiments, the graphical user interface also comprises one or more icons displayed over the graphical representation of the map data. In some embodiments, the one or more icons comprise a number indicative of the quantity of data points within the predetermined area in the map data, for example. A quantity of the one or more icons is based on one or more of the zoom level or a preset limited quantity of data points allowed to be indicated by a single icon. In some embodiments, the reference position is a geographic position in the map data and the preset allowable quantity of data points to be indicated by the single icon is based on the selected zoom level and a predetermined area surrounding the reference position.

In some embodiments, the user interface comprises at least three icons displayed over the graphical representation of the graphical background data, and the at least three icons are equally spaced from one another over the graphical representation of the graphical background data.

In some embodiments, the preset allowable quantity of data points to be indicated by a single icon based on the selected zoom level is a range of quantities, and the user interface comprises at least three icons displayed over the graphical representation of the graphical background data. But, instead of being equally spaced, the at least three icons are spaced from one another over the graphical representation of the graphical background data based on the range of quantities and an allowable distance from a corresponding reference position associated with each of the at least three icons such that two of the at least three icons are displayed closer to one another over the graphical representation of the graphical background data than a third icon of the at least three icons is displayed with respect to the other two icons of the at least three icons over the graphical representation of the graphical background data.

In some embodiments, the one or more icons are free from being displayed having a number indicative of the quantity of data points represented by the icons. In some embodiments, in addition to or in lieu of being displayed having a number indicative of the quantity of data points represented by the icons, one or more icons representative of a quantity of data points greater than a different icon is displayed larger compared to the other icon representative of fewer data points to assist a user in identifying areas in the graphical background data having a higher concentration of data points compared to other areas in the graphical background data. In some embodiments, in addition to or in lieu of being displayed having a number indicative of the quantity of data points represented by the icons, one or more icons representative of a quantity of data points greater than a different icon is displayed in a different color compared to the other icon representative of fewer data points to assist a user in identifying areas in the graphical background data having a higher concentration of data points compared to other areas in the graphical background data. In some embodiments, in addition to or in lieu of being displayed having a number indicative of the quantity of data points represented by the icons, one or more icons representative of a quantity of data points greater than a different icon is displayed having a different shape compared to the other icon representative of fewer data points to assist a user in identifying areas in the graphical background data having a higher concentration of data points compared to other areas in the graphical background data. For example, high data point concentration areas are optionally represented by a red octagon-shaped icon, mid-data point concentration areas are optionally represented by an orange square-shaped icon, and lower-data point concentration areas are optionally represented by a blue circle-shaped icon to assist a user in identifying areas in the graphical background data having a higher concentration of data points compared to other areas in the graphical background data. Of course, other suitable shapes, sizes and colors are optionally used for generating the user interface and the one or more icons displayed therein.

In step 613, management platform 103 causes a quantity of the one or more icons to change based on a change from the selected zoom level to a different zoom level of the plurality of available zoom levels.

In step 615, management platform 103 partitions one or more individual data points from a cluster of data points indicated by at least one of the one or more icons.

For example, upon reaching a zoom level that is greater than any of the pre-processed zoom levels, or if a zoom level is at such a low level of aggregation that an increase in the quantity of icons is allowed in accordance with at least one rule, and/or if the zoom level is at such a low level of aggregation that individual data points are able to be shown based on at least one rule limiting a quantity of individual data points and a quantity of icons to be displayed with respect to the size of the graphical background data being displayed, then one or more of the one or more icons may be split into multiple icons, an icon being representative of a lesser quantity of individual data points and one or more individual data points outside of the displayed icon, or simply one or more individual data points. In some embodiments, the partitioning is done by equally splitting the one or more icons into multiple icons. In some embodiments, the partitioning done in a manner that splits the one or more icons in an uneven manner. For example, in some embodiments, the partition is is done base on a weighting factor assigned to a distance from a center point within a given displayed view in the graphical user interface. For example, if an individual data point is proximate to a center point in the displayed view, and several data points are identified as being outside a preset distance from the center point, then those data points outside the preset distance are clustered, and one or more individual data points within the preset distance are partitioned from the cluster so as to be individually displayed.

In step 617, management platform 103 causes the one or more individual data points to be displayed over the graphical background data in the graphical user interface based on the different zoom level.

In step 619, management platform 103 modifies or deletes one or more of the icons based on the zoom level and the one or more individual data points. In some embodiments, management platform 103 modifies or deletes one or more of the one or more icons based on the change from the selected zoom level to the different zoom level and the one or more individual data points. In some embodiments, in response to a change in the zoom level, or an interaction that is made with an icon, one or more of the numbers, shapes, colors and positions of the one or more icons changes as well.

In step 621, management platform 103 causes at least one of the location information or the identification information to be displayed based on a detected interaction with at least one of the one or more individual data points.

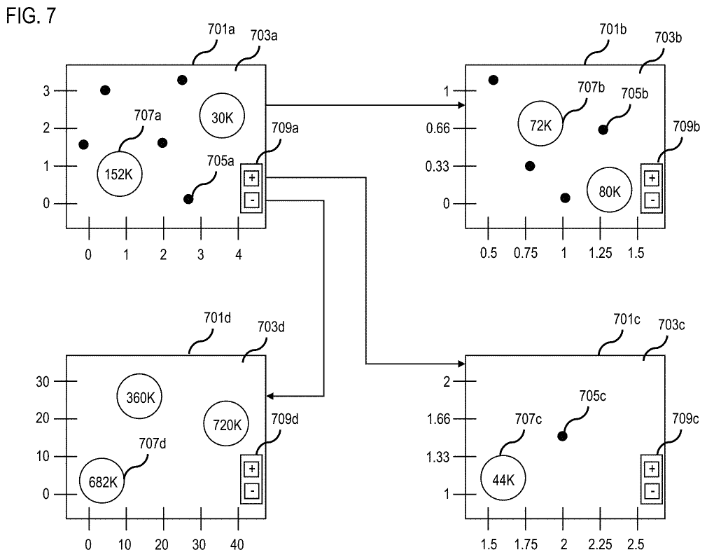

FIG. 7 is a user interface flow diagram utilized in the processes of FIG. 6, according to various embodiments.

User interface screens 701a-701d are example renderings of user interface 311 (FIG. 3) that are caused to be output by a display based on various example user interactions with the user interface 311. User interface 311 comprises a canvas, or a background on which or over which, the aggregate points and summaries are plotted aligning with the summary dimensions. Accordingly, each of user interface screens 701a-701d comprises a corresponding canvas, or background, 703a-703d on which or over which, aggregate points and summaries are plotted aligning with the summary dimensions. User interface screens 703a-703d are shown with the summary dimensions along the outside edges of the user interface screens 703a-703d. In some embodiments, the summary dimensions are included in the rendering displayed. In some embodiments, the summary dimensions are hidden from being shown in the rendering displayed. The aggregate points 705a-705d (collectively referred to as “aggregate points 705”) and summaries 707a-707d (collectively referred to as “summaries 707”) have different visual representations. Summaries 707 appear larger than the individual aggregate points 705. Summaries 707 indicate summary information comprising a quantity of original points which lie within a predetermined distance range of the summary dimensions of the summary 707. In some embodiments, summaries 707 are free from displayed summary information. Aggregate points 705 are individual data points that are displayed outside a summary and with which a user may optionally interact to cause information associated with a selected aggregate point 705 to be displayed. For example, if a user selects an aggregate point 705, at least a portion of one or more of the location information or the identification information associated with the selected aggregate point 705 is displayed. In some embodiments, if a user selects an aggregate point 705 at least some indication of an amount or a value of property associated with a location of the selected aggregate point 705 is displayed. In some embodiments, the display of the information associated with the selected aggregate point 705 is displayed over the background data. In some embodiments, the display of the information associated with the selected aggregate point 705 is displayed on a different user interface screen or window that is caused to be displayed which is free from being over the background data.

If the user interacts with a summary 707a in user interface screen 701a having a quantity of 152 original points displayed, for example, the interaction triggers a change in the view to user interface screen 701b, which is zoomed-in compared to user interface screen 701a and has a lower level of aggregation. The range of the summary dimensions in the new user interface screen 701b is proportional to that of the summary 707a having the quantity of 152 original data points itself within the original user interface screen 701a. The user can continue this pattern, each time with the zoom level increasing, the level of aggregation decreasing, and the range of the summary dimensions decreasing, until there are no summaries 707 left in the view, only aggregate points 705.

User interface 311 comprises a zoom control widget. Zoom control widget is shown in user interface screens 701a-701d as zoom control icons 709a-709d (collectively referred to herein as “zoom control icon 709”). Zoom control icons 709a-709d include a “+” and a “−” that, when toggled, cause a change in the zoom level of the user interface, which directly changes the level of aggregation. For example, if a user interacts with the “+” of zoom control icon 709a, the user interface screen 701a changes to user interface screen 709c, which is a zoomed-in view around the midpoint of the summary dimension ranges in user interface screen 701a, which is the current aggregation window, and accordingly has an increased zoom level compared to user interface screen 701a and has a lower level of aggregation compared to user interface screen 701a. If a user interacts with the “−” of zoom control icon 709a, the user interface screen 701a changes to user interface screen 709d, which is a zoomed-out view around the midpoint of the summary dimension ranges in user interface screen 701a, which is the current aggregation window, and accordingly has a decreased zoom level compared to user interface screen 701a and has a higher level of aggregation compared to user interface screen 701a. Similarly, a user may interact with any of the summaries 707 or zoom control icon 709 from any user interface screen 701, as discussed above. In some embodiments, the zoom control is based on a suitable gesture or interaction with a touch screen or other suitable display in lieu of the zoom control icon, for example, to cause the zoom level to change.

FIG. 8 is a functional block diagram of a computer or processor-based system 800 upon which or by which an embodiment is implemented.

Processor-based system 800 is programmed to generate interactive visualizations of large data sets, as described herein, and includes, for example, bus 801, processor 803, and memory 805 components.

In some embodiments, the processor-based system is implemented as a single “system on a chip.” Processor-based system 800, or a portion thereof, constitutes a mechanism for performing one or more steps of generating interactive visualizations of large data sets.

In some embodiments, the processor-based system 800 includes a communication mechanism such as bus 801 for transferring information and/or instructions among the components of the processor-based system 800. Processor 803 is connected to the bus 801 to obtain instructions for execution and process information stored in, for example, the memory 805. In some embodiments, the processor 803 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 803. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 803 performs a set of operations on information as specified by a set of instructions stored in memory 805 related to generating interactive visualizations of large data sets. The execution of the instructions causes the processor to perform specified functions.

The processor 803 and accompanying components are connected to the memory 805 via the bus 801. The memory 805 includes one or more of dynamic memory (e.g., RAM, magnetic disk, writable optical disk, etc.) and static memory (e.g., ROM, CD-ROM, etc.) for storing executable instructions that when executed perform the steps described herein to generate interactive visualizations of large data sets. The memory 805 also stores the data associated with or generated by the execution of the steps.

In one or more embodiments, the memory 805, such as a random access memory (RAM) or any other dynamic storage device, stores information including processor instructions for generating interactive visualizations of large data sets. Dynamic memory allows information stored therein to be changed by system 800. RAM allows a unit of information stored at a location called a memory address to be stored and retrieved independently of information at neighboring addresses. The memory 805 is also used by the processor 803 to store temporary values during execution of processor instructions. In various embodiments, the memory 805 is a read only memory (ROM) or any other static storage device coupled to the bus 801 for storing static information, including instructions, that is not changed by the system 800. Some memory is composed of volatile storage that loses the information stored thereon when power is lost. In some embodiments, the memory 805 is a non-volatile (persistent) storage device, such as a magnetic disk, optical disk or flash card, for storing information, including instructions, that persists even when the system 800 is turned off or otherwise loses power.

The term “computer-readable medium” as used herein refers to any medium that participates in providing information to processor 803, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description relates to a method that comprises extracting data from a log file including location information and identification information, the extracting being performed by a computer system configured to recognize and parse the data within the log file for each of a plurality of different file formats to enable a monitoring system implemented by a processor to oversee data activity across one or more of a plurality of applications or one or more computer environments for determining a quantity of data points based on a correspondence between the identification information and the location information. The method also comprises normalizing the data based on a predefined format. The method further comprises processing the normalized data to determine at least one of the quantity of data points corresponds to the location information. The method additionally comprises processing graphical background data to determine a plurality of available zoom levels, the available zoom levels of the plurality of available zoom levels being indicative of an amount of graphical background data displayed by way of a user interface comprising the graphical background data. The method also comprises processing the normalized data with respect to the graphical background data and each zoom level of the plurality of available zoom levels to determine a quantity of data points within a predetermined distance from a reference position in the graphical background data. The method further comprises causing a graphical user interface to be output by a display. The graphical user interface comprises a graphical representation of the graphical background data at a selected zoom level of the plurality of available zoom levels. The graphical user interface also comprises one or more icons displayed over the graphical representation of the graphical background data, the one or more icons comprising a number indicative of the quantity of data points within the predetermined distance of the reference position, wherein a quantity of the one or more icons is based on a preset allowable quantity of data points to be indicated by a single icon based on the selected zoom level. The method additionally comprises causing a quantity of the one or more icons to change based on a change from the selected zoom level to a different zoom level of the plurality of available zoom levels. The method further comprises partitioning one or more individual data points from a cluster of data points indicated by at least one of the one or more icons. The method additionally comprises causing the one or more individual data points to be displayed over the graphical background data in the graphical user interface based on the different zoom level.

Another aspect of this description relates to an apparatus comprising a processor and a memory having computer readable instructions stored thereon that, when executed by the processor, cause the apparatus to extract data from a log file including location information and identification information, the extracting being performed by a computer system configured to recognize and parse the data within the log file for each of a plurality of different file formats to enable a monitoring system implemented by a processor to oversee data activity across one or more of a plurality of applications or one or more computer environments for determining a quantity of data points based on a correspondence between the identification information and the location information. The apparatus is also caused to normalize the data based on a predefined format. The apparatus is further caused to process the normalized data to determine at least one of the quantity of data points corresponds to the location information. The apparatus is additionally caused to process graphical background data to determine a plurality of available zoom levels, the available zoom levels of the plurality of available zoom levels being indicative of an amount of graphical background data displayed by way of a user interface comprising the graphical background data. The apparatus is also caused to process the normalized data with respect to the graphical background data and each zoom level of the plurality of available zoom levels to determine a quantity of data points within a predetermined distance from a reference position in the graphical background data. The apparatus is further caused to cause a graphical user interface to be output by a display. The graphical user interface comprises a graphical representation of the graphical background data at a selected zoom level of the plurality of available zoom levels. The graphical user interface also comprises one or more icons displayed over the graphical representation of the graphical background data, the one or more icons comprising a number indicative of the quantity of data points within the predetermined distance of the reference position, wherein a quantity of the one or more icons is based on a preset allowable quantity of data points to be indicated by a single icon based on the selected zoom level. The apparatus is additionally caused to cause a quantity of the one or more icons to change based on a change from the selected zoom level to a different zoom level of the plurality of available zoom levels. The apparatus is also caused to partition one or more individual data points from a cluster of data points indicated by at least one of the one or more icons. The apparatus is further caused to cause the one or more individual data points to be displayed over the graphical background data in the graphical user interface based on the different zoom level.

Another aspect of this description relates to a non-transitory computer readable medium having instructions stored thereon that, when executed by a processor, cause an apparatus to extract data from a log file including location information and identification information, the extracting being performed by a computer system configured to recognize and parse the data within the log file for each of a plurality of different file formats to enable a monitoring system implemented by a processor to oversee data activity across one or more of a plurality of applications or one or more computer environments for determining a quantity of data points based on a correspondence between the identification information and the location information. The apparatus is also caused to normalize the data based on a predefined format. The apparatus is further caused to process the normalized data to determine at least one of the quantity of data points corresponds to the location information. The apparatus is additionally caused to process graphical background data to determine a plurality of available zoom levels, the available zoom levels of the plurality of available zoom levels being indicative of an amount of graphical background data displayed by way of a user interface comprising the graphical background data. The apparatus is also caused to process the normalized data with respect to the graphical background data and each zoom level of the plurality of available zoom levels to determine a quantity of data points within a predetermined distance from a reference position in the graphical background data. The apparatus is further caused to cause a graphical user interface to be output by a display. The graphical user interface comprises a graphical representation of the graphical background data at a selected zoom level of the plurality of available zoom levels. The graphical user interface also comprises one or more icons displayed over the graphical representation of the graphical background data, the one or more icons comprising a number indicative of the quantity of data points within the predetermined distance of the reference position, wherein a quantity of the one or more icons is based on a preset allowable quantity of data points to be indicated by a single icon based on the selected zoom level. The apparatus is additionally caused to cause a quantity of the one or more icons to change based on a change from the selected zoom level to a different zoom level of the plurality of available zoom levels. The apparatus is also caused to partition one or more individual data points from a cluster of data points indicated by at least one of the one or more icons. The apparatus is further caused to cause the one or more individual data points to be displayed over the graphical background data in the graphical user interface based on the different zoom level.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
extracting data from a log file including location information and identification information, the extracting being performed by a computer system configured to recognize and parse the data within the log file for each of a plurality of different file formats to enable a monitoring system implemented by a processor to oversee data activity across one or more of a plurality of applications or one or more computer environments for determining a quantity of data points based on a correspondence between the identification information and the location information;
normalizing the data based on a predefined format;
processing the normalized data to determine at least one of the quantity of data points corresponds to the location information;
processing graphical background data to determine a plurality of available zoom levels, the available zoom levels of the plurality of available zoom levels being indicative of an amount of graphical background data displayed by way of a user interface comprising the graphical background data;
processing the normalized data with respect to the graphical background data and each zoom level of the plurality of available zoom levels to determine a quantity of data points within a predetermined distance from a reference position in the graphical background data;
causing a graphical user interface to be output by a display, the graphical user interface comprising:
a graphical representation of the graphical background data at a selected zoom level of the plurality of available zoom levels; and
one or more icons displayed over the graphical representation of the graphical background data, the one or more icons comprising a number indicative of the quantity of data points within the predetermined distance of the reference position, wherein a quantity of the one or more icons is based on a preset allowable quantity of data points to be indicated by a single icon based on the selected zoom level;
causing a quantity of the one or more icons to change based on a change from the selected zoom level to a different zoom level of the plurality of available zoom levels;
partitioning one or more individual data points from a cluster of data points indicated by at least one of the one or more icons; and
causing the one or more individual data points to be displayed over the graphical background data in the graphical user interface based on the different zoom level.

2. The method of claim 1, wherein the location information comprises one or more of a geographical location or a property address.

3. The method of claim 2, wherein the identification information comprises data associated with one or more of a date, a time, a person, a surname, a first name, a personal identifier, a birth date, a person's sex, a social security number, an ancestral tree, money, or a tangible asset.

4. The method of claim 1, wherein the graphical background data comprises map data.

5. The method of claim 4, wherein the reference position is a geographic position in the map data and the preset allowable quantity of data points to be indicated by the single icon is based on the selected zoom level and a predetermined area surrounding the reference position.

6. The method of claim 4, wherein the map data comprises a three-dimensional space.

7. The method of claim 1, further comprising:
modifying or deleting one or more of the one or more icons based on the change from the selected zoom level to the different zoom level and the one or more individual data points; and
causing at least one of the location information or the identification information to be displayed based on a detected interaction with at least one of the one or more individual data points.

8. The method of claim 1, wherein
the monitoring system continuously processes the normalized data according to a predefined schedule to generate the one or more icons for a preset quantity of the plurality of available zoom levels such that the one or more icons at the zoom levels of the preset quantity of zoom levels are fixed based on the normalized data and a first time at which the normalized data is processed according to the predefined schedule, and
the monitoring system processes the normalized data based on a user interaction with the user interface at a second time after the normalized data is processed according to the predefined schedule, to cause the one or more icons to change based on a determination the zoom level is greater than the zoom levels of the preset quantity of zoom levels.

9. The method of claim 1, wherein the user interface comprises at least three icons displayed over the graphical representation of the graphical background data, and the at least three icons are equally spaced from one another over the graphical representation of the graphical background data.

10. The method of claim 1, wherein
the preset allowable quantity of data points to be indicated by a single icon based on the selected zoom level is a range of quantities,
the user interface comprises at least three icons displayed over the graphical representation of the graphical background data, and
the at least three icons are spaced from one another over the graphical representation of the graphical background data based on the range of quantities and an allowable distance from a corresponding reference position associated with each of the at least three icons such that two of the at least three icons are displayed closer to one another over the graphical representation of the graphical background data than a third icon of the at least three icons is displayed with respect to the other two icons of the at least three icons over the graphical representation of the graphical background data.

11. An apparatus comprising:
a processor; and
a memory having computer readable instructions stored thereon that, when executed by the processor, cause the apparatus to:
extract data from a log file including location information and identification information, the extracting being performed by a computer system configured to recognize and parse the data within the log file for each of a plurality of different file formats to enable a monitoring system implemented by a processor to oversee data activity across one or more of a plurality of applications or one or more computer environments for determining a quantity of data points based on a correspondence between the identification information and the location information;
normalize the data based on a predefined format;
process the normalized data to determine at least one of the quantity of data points corresponds to the location information;
process graphical background data to determine a plurality of available zoom levels, the available zoom levels of the plurality of available zoom levels being indicative of an amount of graphical background data displayed by way of a user interface comprising the graphical background data;
process the normalized data with respect to the graphical background data and each zoom level of the plurality of available zoom levels to determine a quantity of data points within a predetermined distance from a reference position in the graphical background data;
cause a graphical user interface to be output by a display, the graphical user interface comprising:
a graphical representation of the graphical background data at a selected zoom level of the plurality of available zoom levels; and
one or more icons displayed over the graphical representation of the graphical background data, the one or more icons comprising a number indicative of the quantity of data points within the predetermined distance of the reference position, wherein a quantity of the one or more icons is based on a preset allowable quantity of data points to be indicated by a single icon based on the selected zoom level;
cause a quantity of the one or more icons to change based on a change from the selected zoom level to a different zoom level of the plurality of available zoom levels;
partition one or more individual data points from a cluster of data points indicated by at least one of the one or more icons; and
cause the one or more individual data points to be displayed over the graphical background data in the graphical user interface based on the different zoom level.

12. The apparatus of claim 11, wherein the location information comprises one or more of a geographical location or a property address.

13. The apparatus of claim 12, wherein the identification information comprises data associated with one or more of a date, a time, a person, a surname, a first name, a personal identifier, a birth date, a person's sex, a social security number, an ancestral tree, money, or a tangible asset.

14. The apparatus of claim 11, wherein the graphical background data comprises map data and the reference position is a geographic position in the map data and the preset allowable quantity of data points to be indicated by the single icon is based on the selected zoom level and a predetermined area surrounding the reference position.

15. The apparatus of claim 11, further comprising:
modifying or deleting one or more of the one or more icons based on the change from the selected zoom level to the different zoom level and the one or more individual data points; and
causing at least one of the location information or the identification information to be displayed based on a detected interaction with at least one of the one or more individual data points.

16. The apparatus of claim 11, wherein
the monitoring system continuously processes the normalized data according to a predefined schedule to generate the one or more icons for a preset quantity of the plurality of available zoom levels such that the one or more icons at the zoom levels of the preset quantity of zoom levels are fixed based on the normalized data and a first time at which the normalized data is processed according to the predefined schedule, and
the monitoring system processes the normalized data based on a user interaction with the user interface at a second time after the normalized data is processed according to the predefined schedule, to cause the one or more icons to change based on a determination the zoom level is greater than the zoom levels of the preset quantity of zoom levels.

17. The apparatus of claim 11, wherein the user interface comprises at least three icons displayed over the graphical representation of the graphical background data, and the at least three icons are equally spaced from one another over the graphical representation of the graphical background data.

18. The apparatus of claim 11, wherein
the preset allowable quantity of data points to be indicated by a single icon based on the selected zoom level is a range of quantities,
the user interface comprises at least three icons displayed over the graphical representation of the graphical background data, and
the at least three icons are spaced from one another over the graphical representation of the graphical background data based on the range of quantities and an allowable distance from a corresponding reference position associated with each of the at least three icons such that two of the at least three icons are displayed closer to one another over the graphical representation of the graphical background data than a third icon of the at least three icons is displayed with respect to the other two icons of the at least three icons over the graphical representation of the graphical background data.

19. The apparatus of claim 11, wherein the graphical background data comprises a three-dimensional space.

20. A non-transitory computer readable medium having instructions stored thereon that, when executed by a processor, cause an apparatus to:
extract data from a log file including location information and identification information, the extracting being performed by a computer system configured to recognize and parse the data within the log file for each of a plurality of different file formats to enable a monitoring system implemented by a processor to oversee data activity across one or more of a plurality of applications or one or more computer environments for determining a quantity of data points based on a correspondence between the identification information and the location information;
normalize the data based on a predefined format;
process the normalized data to determine at least one of the quantity of data points corresponds to the location information;
process graphical background data to determine a plurality of available zoom levels, the available zoom levels of the plurality of available zoom levels being indicative of an amount of graphical background data displayed by way of a user interface comprising the graphical background data;
process the normalized data with respect to the graphical background data and each zoom level of the plurality of available zoom levels to determine a quantity of data points within a predetermined distance from a reference position in the graphical background data;
cause a graphical user interface to be output by a display, the graphical user interface comprising:
a graphical representation of the graphical background data at a selected zoom level of the plurality of available zoom levels; and
one or more icons displayed over the graphical representation of the graphical background data, the one or more icons comprising a number indicative of the quantity of data points within the predetermined distance of the reference position, wherein a quantity of the one or more icons is based on a preset allowable quantity of data points to be indicated by a single icon based on the selected zoom level;
cause a quantity of the one or more icons to change based on a change from the selected zoom level to a different zoom level of the plurality of available zoom levels;
partition one or more individual data points from a cluster of data points indicated by at least one of the one or more icons; and
cause the one or more individual data points to be displayed over the graphical background data in the graphical user interface based on the different zoom level.
